(19) United States
(12) Patent Application Publication
(10) Pub. No.: US 2006/0019706 A1
(43) Pub. Date: Jan. 26, 2006

(54) Mobile phone with mouse device

(75) Inventors: David Ho, Taipei Hsien (TW); Yi-Min Zhu, Shanghai City (CN); Qi Wang, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,958

(22) Filed: Jul. 20, 2004

(51) Int. Cl. H04M 1/00; H04B 1/38

(52) U.S. Cl. 455/556.2; 455/556.1

(57) ABSTRACT

The present invention discloses a mobile phone having a mouse device that allows users to easily control a pointer on a screen or quickly open a dialog box. The mobile phones of the invention comprises a screen, a mouse device, and two function keys on the mobile phone; wherein the screen can display the pointer or an option box, and the mouse device is used to control the position of the pointer on that screen, and the two function keys are used to turn on and off the option box or respond to an enter key for executing a certain specific function.

### FIELD OF THE INVENTION

The present invention relates to mobile phones, more particularly to a mobile phone having a mouse device that allows users to easily control a pointer on a screen, quickly open a dialog box, turn on and off an option box or respond to an enter key for executing a certain specific function.

### BACKGROUND OF THE INVENTION

Our life has entered into at a booming communication technological development stage for a new era. As to the world, mobile phones have created a hot wave of telecommunications in recent years. In the early 1990, there were only 1,000 mobile communication users in the world. After a decade, the number of mobile communication users has exceeded 350,000,000. According to the International Telecommunication Union (ITU), the statistics indicate that the number of mobile phone users will be 500,000,000 till the end of 2003, which will be approximately half of the number of traditional telephone users (950,000,000). Conservatively speaking, the number of mobile phone users will be far more than that of traditional users by 2005. Mobile communications will become the mainstream of telecommunications. The cellular phone has created a revolutionary change to the telephone technology. Mobile communication is no long a station-to-station calling, but is a person-to-person communication. In addition, since mobile phones are light, nice looking, portable, reasonably priced, as well as having the roaming feature via network, therefore the mobile communication is not limited by space anymore, but it can be used anywhere anytime, and thus becoming a necessity of our daily communications.

To date, the development of mobile phones has changed from the original voice transmission medium to the current information transmission function. As to the types of data transmission, the transmission method of the first generation handset follows the analog specification, and the contents of transmission are mainly voice. The effects on the confidentiality and penetration of the communications via such handset are not good at all. The transmission method of the second generation handset is via digital transmission. After the voice is digitized and coded, the digital data is transmitted by packets, and thus enhancing the confidentiality of the communications. However, in the present network era, the demand for digital Internet and wireless Internet communications gradually increases. With the concept of information appliances and IA products, mobile phones are classified as an important integration, control, and communications unit. Then, the requirements for data transmission volume of mobile phones have increased greatly. At the beginning of establishing the second generation handset specification, only the voice transmission and processing are taken into consideration. The volume of digital voice data is not large, and thus the second generation handset with 9.6 Kbps transmission rate is sufficient. However, if it is necessary to process data including graphic and text files, then the transmission rate of the second generation handsets is definitely not enough. The telecommunications specifications of the 2.5^{th} and 3^{rd} generations are developed for dealing with the huge data volume in this network era. At present, the transmission rate of the 2.5^{th} generation telecommunications specification has reached 115 Kbps. With the greatly improved transmission rate, the requirements for the transmission of static screens are met. Therefore, the objective for wireless networking is finally achieved by establishing the 2.5^{th} generation specification. The establishment of the third generation specification further increases the transmission rate up to 2.4 Mbps, which makes the transmission of dynamic images via mobile phones possible. With the arrival of the 3G era in the future, we can even watch television programs or movies or conduct a person-to-person telecommunication conference via mobile phones. The 3G era will make our life more convenient, the access of information faster, and the link between communications, information and network more closely.

The structure of handset is divided into two parts: software and hardware. The hardware is divided into a basic frequency module, a middle frequency module, a radio frequency module (RF), and other components. The radio frequency module is mainly comprised of a power amplifier (PA), a transmission receiver, a synthesizer; the middle frequency uses the AD and DA signal converters as the main structure; the basic frequency module includes a digital signal processor (DSP), a microcontroller (MCU), and a memory; and other components include a casing, a liquid crystal display (LCD), a printed circuit board (PCB), an antenna, a keypad, a speaker, a microphone, a subscriber identification module (SIM) card, and a battery, etc.

In the basic operation of a mobile phone, after the antenna receives a signal, the signal is sent to the radio frequency module for amplifying and receiving the signal, and then the analog signal is converted into a digital signal by the AD and DA converter, and finally the DSP of the basic frequency module processes the digital signal.

The present mobile phone tends to be developed with a color screen which has become a mainstream to cope with the software operated with icons or Windows software. Further, the notes function of a personal digital assistant (PDA) is integrated into the mobile phone, so that a mobile phone is just like a set of small computer. Therefore, it is very inconvenient if we have to use the press buttons on a mobile phone to control the pointer on the screen or open a dialog box. If we have to carry a mouse with us all the time, the features with the all-in-one function and portability no longer exist. Therefore, if there is a design that allows mobile phone users to easily control the pointer on a screen or open a dialog box, then it will bring tremendous convenience to a large population of consumers. As to the telecommunications technology, it is also a great contribution.

### SUMMARY OF THE INVENTION

The primary objective of the present invention is to provide a design for mobile phone users to easily control a pointer on a screen or quickly open a dialog box by installing a screen, a mouse device, and two function keys on the mobile phone; wherein the screen can display the pointer or an option box, and the mouse device is used to control the position of the pointer on that screen, and the two function keys are used to turn on and off the option box or respond to an enter key for executing a certain specific function.

### BRIEF DESCRIPTION OF THE DRAWINGS

FIG. 1 is a block diagram of the structure of the present invention.

FIG. 2 is a perspective view of the mobile phone according to a first preferred embodiment of the present invention.

FIG. 3 is a perspective view of the mobile phone according to a second preferred embodiment of the present invention.

### DETAILED DESCRIPTION OF THE PREFERRED EMBODIMENTS

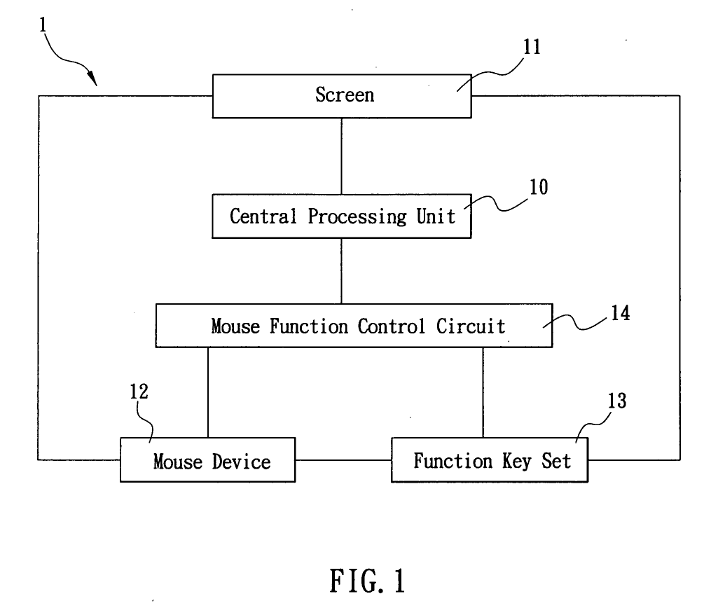

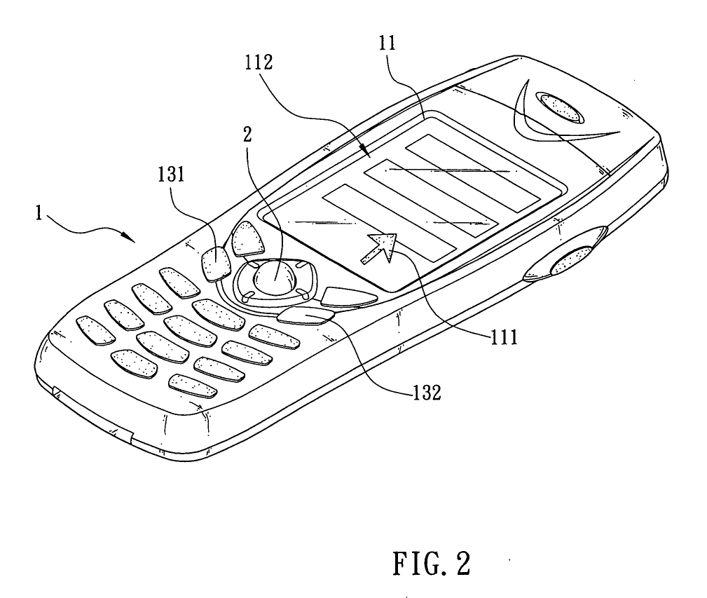

Please refer to FIGS. 1 and 2 for the mobile phone with a mouse device comprising a central processing unit 10, a screen 11, a mouse device 12, a function key set 13, and a mouse function control circuit 14; wherein the screen 11 can display a pointer 111 or an option box 112; the mouse device 12 is used to control the moving position of the pointer 111 on the screen 11; the function key set 13 can be used to open or close the option box 112 or respond to the enter key for executing a certain specific function; and the mouse function control circuit acts as a control interface between the central processing unit 10 and the mouse device 12.

Please refer to FIGS. 1 and 2 for the first preferred embodiment of the present invention. The mouse device 12 could be a wheel mouse 2, and the function key set 13 is divided into a left button 131 and a right button 132, so that a user can use one hand to hold the mobile phone 1, and a thumb to touch and drag the wheel mouse 2 in order to control the moving position of the pointer 11 on the screen 11. Further, the user can use a thumb to click the left button 131 or the right button to open or close the option box 112 or respond to the enter key for executing a certain specific function.

In FIGS. 1 and 2, the casing of the mobile phone 1 according to a first preferred embodiment of the present invention comprises a resilient press button (not shown in the figure) corresponding to the pointer mouse 2. Such innovative idea allows users to use a finger to press the pointer mouse 2, so that the pointer mouse 2 sinks into the surface of the casing of the mobile phone 1 and presses the resilient press button to execute or terminate a program, open or close an option box 112, receive or hang up a telephone call, and turn on or off the power supply of the mobile phone 1. If the figure stops pressing on the wheel mouse 2, the resilient press button will push the wheel mouse 2 upward, such that the wheel mouse 2 resumes its position back to the surface of the casing of the mobile phone 1.

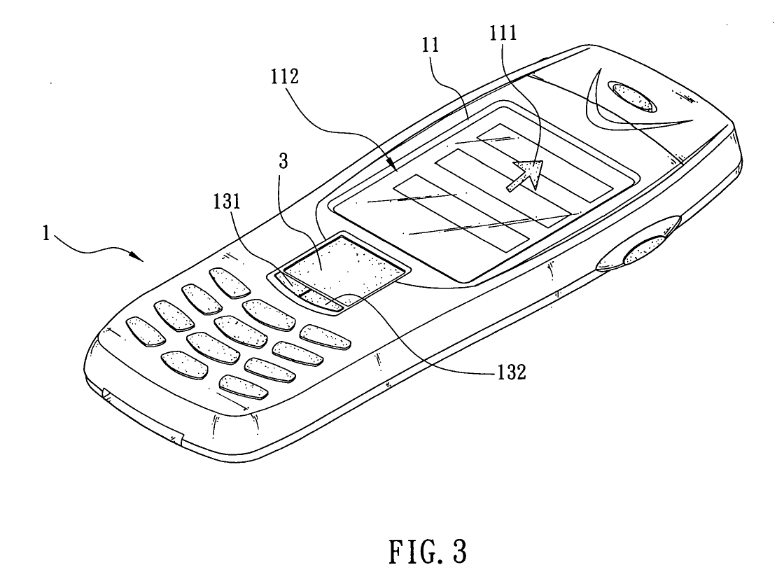

Please refer to FIGS. 1 and 3 for the second preferred embodiment of the present invention. The mouse device 12 could be a touch pad 3 and the function key set 13 also comprises a left button 131 and a right button 132, so that a user can hold the mobile phone by a hand and use the index finger of another hand to touch the touch pad 13 to control the moving position of the pointer 111 on the screen 11, and use the thumb or the index figure to press the left button 131 or the right button 132 to open or close the option box 112 or respond to the enter key for executing a certain specific function.

Please refer to FIGS. 1 to 3 again. The mobile phone 1 of the present invention can install a software program operated by icons or a Window software program. Further, the mobile phone could be a low power mobile phone system such as the personal handphone system (PHS), a high power mobile phone system such as the global system for mobile communication (GSM), or a smart phone which integrates both functions of a handset and a personal digital assistant.

While the invention has been described by means of specific embodiments, numerous modifications and variations could be made thereto by those skilled in the art without departing from the scope and spirit of the invention set forth in the claims.

What is claimed is:

1. A mobile phone with mouse device, having a central processing unit installed in a mobile phone, and said central processing unit being coupled to the following components to control the operation of said mobile phone:
a screen, for selectively display a pointer and an option box;
a mouse device, disposed on a surface of said mobile phone at an easy-to-operate position for controlling the moving position of said pointer on said screen;
a function key set, for selectively opening and closing said option box and responding to an enter key for executing a function;
a mouse function control circuit, acting as a control interface between said central processing unit, said mouse device, and said function key set.

2. The mobile phone with mouse device of claim 1, wherein said mouse device is a wheel mouse, and said function key set is divided into a left button and a right button, thereby said wheel mouse is dragged to control the moving position of said pointer on said screen, and one of said left button and said right button is pressed to selectively open and close said option box and respond to an enter key for executing a function.

3. The mobile phone with mouse device of claim 2, wherein said mouse device comprises a resilient press button corresponding to said wheel mouse being disposed in said casing of said mobile phone, thereby when said wheel mouse is pressed, said wheel mouse sinks into a surface of said casing of said mobile phone, and further presses on said resilient press button; when said wheel mouse is released, said resilient press button pushes said wheel mouse upward, such that said wheel mouse resumes its position back to the surface of said casing of said mobile phone.

4. The mobile phone with mouse device of claim 3, wherein said resilient press button is a power supply switch of said mobile phone.

5. The mobile phone with mouse device of claim 1, wherein said mouse device is a touch pad and said function key set is divided into a left button and a right button, thereby said touch pad is touched and dragged to control the moving position of said pointer on said screen, and one of said left button and said right button is pressed to selectively open and close said option box and respond to an enter key for executing a function.

6. The mobile phone with mouse device of claim 1, wherein said mobile phone installs a software program with icon operations.

7. The mobile phone with mouse device of claim 1, wherein said mobile phone installs a Windows operating software program.

8. The mobile phone with mouse device of claim 1, wherein said mobile phone is a low power mobile phone system.

9. The mobile phone with mouse device of claim 1, wherein said mobile phone is a high power mobile phone system.

10. The mobile phone with mouse device of claim 1, wherein said mobile phone is smart phone integrating the functions of a handset and a personal digital assistant.
